(19) United States
(12) Patent Application Publication
(10) Pub. No.: US 2013/0036812 A1
(43) Pub. Date: Feb. 14, 2013

(54) METHOD AND APPARATUS FOR DETECTING TIGHTNESS OF THREADED JOINTS OF DRILL RODS

(71) Applicants: Tuomo Pirinen, Tampere (FI); Vesa Uitto, Tampere (FI); Joona Hakala, Tampere (FI); Anssi Klapuri, London (GB)

(72) Inventors: Tuomo Pirinen, Tampere (FI); Vesa Uitto, Tampere (FI); Joona Hakala, Tampere (FI); Anssi Klapuri, London (GB)

(73) Assignee: SANDVIK MINING AND CONSTRUCTION OY, Tampere (FI)

(21) Appl. No.: 13/695,813

(22) PCT Filed: May 3, 2011
(86) PCT No.: PCT/FI11/50406

§ 371 Date: Nov. 2, 2012

(30) Foreign Application Priority Data
May 4, 2010 (FI) 20105487

(51) Int. Cl. F16B 31/00; E21B 47/00

(52) U.S. Cl. 73/152.52; 73/760; 73/862; 73/152.01; 73/570

(57) ABSTRACT

The invention relates to a method and an apparatus for detecting tightness of threaded joints of drill rods when unfastening at least one threaded joint of the drilling equipment (6) by impacting the drilling equipment (6) with a percussion device in the rock drilling rig (1). For detecting the tightness there is predetermined at least one fastened model for a situation where the threaded joint/joints are fastened, a vibration signal measured during impacting is compared with both the fastened model and the unfastened model and, on the basis of the comparison, it is determined to which one of the models the tightness of the threaded joints better corresponds at the moment of determination.

### BACKGROUND OF THE INVENTION

The invention relates to a method for detecting tightness of threaded joints of drill rods when unfastening at least one threaded joint of drilling equipment by impacting the drilling equipment with a percussion device of a rock drilling rig, the method predetermining at least one unfastened model for a situation where the threaded joint is unfastened, based on vibration produced in the drilling equipment while being impacted, measuring vibration originating from the drilling equipment during impacting and comparing a measured vibration signal with the model so as to determine the tightness in the threaded joint(s).

Further, the invention relates to an apparatus for detecting tightness of threaded joints of drill rods when unfastening at least one threaded joint of drilling equipment by impacting the drilling equipment with a percussion device of a rock drilling rig, the apparatus comprising a control device for controlling the rock drilling rig, memory means for storing a predetermined unfastened model, which represents the situation where the threaded joints of the drilling equipment are unfastened, a measuring device for measuring vibration originating from the drill rod during impacting, and analyzing means for analyzing the measured vibration in accordance with a predetermined principle and for comparing with the unfastened model so as to determine whether the threaded joints have come unfastened.

When holes are drilled in rock or ground, there is employed drilling equipment, in which one or more drill rods, a drill bit and optionally a drill shank are interconnected by threaded joints. In so-called down-the-hole drilling (DTH drilling) a drill bit in the drilling equipment is usually connected to a down-the-hole drill, provided with a percussion device and locating at the bottom of the hole, which drill is further connected to drill pipes interconnected by threaded joints and extending to the ground surface, the pipes enabling rotation. Hereinafter, both drill rods and drill pipes will be referred to as drill rods. During drilling, the threaded joints tighten up due to both rotation torque and impacts delivered thereto during drilling by a percussion device and the resulting waves of stress and torsion, and, in practice, they are generally unopenable by a rotating motor alone.

As known, attempts have been made to solve this problem such that after completed hole drilling the operator has impacted the drill rods with the percussion device, when feed force is not exerted thereon, whereby a suitable number of impacts causes the threads to loosen. The operator performs this on the basis of experience and stops impacting normally as he perceives a particular sound or vibration from the drilling equipment or detects in another manner that the threads have loosened.

In practice, the problem is that it is difficult to detect the loosening of the threads in a reliable manner and it does not always succeed the first time. Another problem is that unnecessary impacting, when the threads are already unfastened, may wear and even damage the drilling equipment. In addition, there is a risk that the threaded joints come open completely and parts of the drilling equipment are detached from one another and fall in the hole. Further, the fact that the operator has to perform this manually prevents automation.

Various attempts have been made to provide automated disassembly of a drill rod and detection of thread loosening. These have been disclosed, inter alia, in publications EP 1671011, JP56966/1986 and JP 1864566. However, solutions disclosed in these publications are not, in practice, fully reliable in operation. These require either highly detailed and precise, characteristic vibration patterns or case-specific values, and nevertheless their use is limited almost device-specifically such that settings for one device cannot be used in other similar devices or as conditions change.

### BRIEF DESCRIPTION OF THE INVENTION

The object of this invention is to provide a method and an apparatus, whereby loosening of threads may be performed reliably and, when necessary, automated completely.

The method of the invention is characterized by also predetermining at least one fastened model for a situation where the threaded joint/joints are fastened, comparing a vibration signal measured during impacting with both the fastened model and the unfastened model and, on the basis of the comparison, determining to which one of the models the tightness of the threaded joints corresponds better at the moment of determination.

The apparatus of the invention is characterized in that in the memory means there is also stored in advance at least one fastened model, which represents a situation where the threaded joints of the drilling equipment are fastened, that the analyzing means are arranged to compare the vibration signal measured during impacting with both the fastened model and the unfastened model, and on the basis of the comparison, to determine to which one of the models the tightness of the threaded joints corresponds better at the moment of determination.

The basic idea of the invention is to predetermine models both for vibration that indicates the threads being tightly fastened and for vibration that indicates the threads being unfastened. Further, the signal measured during impacting is compared during impacting with the fastened model and the unfastened model, and on the basis of these comparisons it is determined which one of the models the measured signal approaches more closely. On the basis of this comparison, it is correspondingly concluded, i.e. determined, whether the threads are fastened or unfastened at the moment of measuring.

In an embodiment of the invention, between the fastened model and the unfastened model there is determined a separate threshold condition, e.g. mathematically or by employing in the determination of the threshold condition an experienced operator on the basis of whose performance in impacting and, in particular, in stopping the impacting situation there is determined the value serving as a threshold value, on one side of which, according to the vibration measured in model comparison, the threads are fastened and on the other side the threads are unfastened.

In the method of the invention and by the apparatus thereof, detection of the state of the threaded joint or joints is more reliable and can be more readily automated than in known solutions, because accurate congruence of models is not needed, but comparisons between two different models can be made using rougher models and, thus, it is easier to find out what the actual situation is. Moreover, when the threshold condition is determined such that its position between the fastened model and the unfastened model can be changed, for instance, as the circumstances change or the drilling equipment changes, the method is readily applicable both in the same device in different circumstances and in different devices.

Further, by providing a plurality of models for different drilling equipment, drilling conditions etc., the method may be applied widely depending on different situations. The solution of this invention does not necessitate accurate, detailed conditions for vibration properties, but by means of the models it is possible to widely describe the effect of the tightness and changes therein on the vibration properties. The models describe vibration and its properties in different tightness states in general, whereby case-specific values or settings are not needed. Instead, the models cover differences in circumstances, equipment and devices and they will be automatically taken into account. In addition, the solution of this invention employs models for both fastened and unfastened threaded joints, and correspondence in vibration is compared with these models. The vibration and its properties need not correspond accurately to the models in order to allow conclusions on the state of tightness. Hence, it is more reliable than in previous solutions to determine the tightness.

### BRIEF DESCRIPTION OF THE FIGURES

The invention is now described in greater detail in the attached drawings, in which

FIG. 1 is a schematic view of a rock drilling rig,

FIG. 2 shows schematically the principle of the method in accordance with the invention,

FIG. 3 shows schematically a manner to form the method of the invention and the system implementing its application,

FIG. 4 shows schematically a manner to apply the method of the invention, and

FIG. 5 shows schematically, and by way of example, a manner to apply the method of the invention.

### DETAILED DESCRIPTION OF THE INVENTION

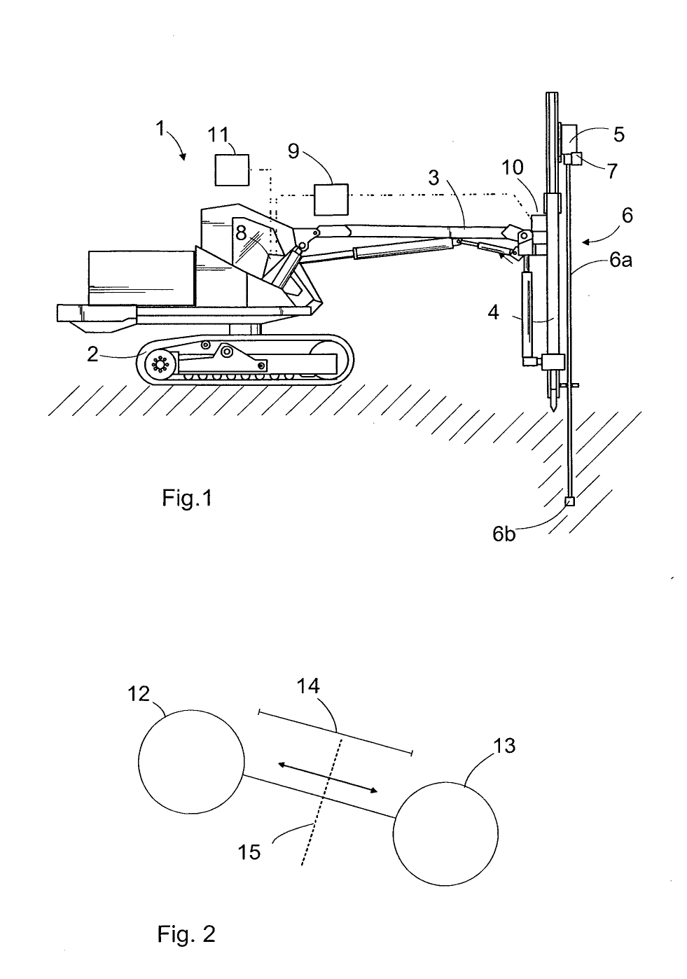

FIG. 1 shows schematically a rock drilling rig 1 comprising a carrier 2, to which a boom 3 is connected. At one end of the boom 3 there is connected a feed beam 4 along which a rock drilling machine 5 moves during use. To the rock drill 5 is coupled drilling equipment 6 which is rotated and impacted with a percussion device, included in the rock drill, during drilling.

The drilling equipment 6 comprises one or more drill rods 6a and a drill bit 6b, which are interconnected by threaded joints in a manner known per se. In other rock drilling rigs, the drilling equipment also includes a drill shank, which is not shown here but which is known per se to a person skilled in the art and which is generally located inside the rock drilling machine. Rock drilling rigs of this kind, and the operation thereof, are commonly known per se, and therefore they need not be described in detail.

The rock drilling machine 5 of the rock drilling rig 1 comprises a percussion device known per se and used in drilling. Its operation and structure are commonly known, and therefore it is not necessary to describe it in any greater detail. For unfastening the threaded joints of the drilling equipment 6 the drilling equipment is impacted with the percussion device of the rock drilling rig and possibly rotated in the thread-unfastening direction with a rotating motor 7 included in the rock drilling rig and known per se. Thus, forces generated in the drilling equipment gradually make the threaded joints loosen.

The rock drilling rig 1 also comprises a control device 8 that controls the operations of the rock drilling rig during drilling and other use. The control device 8 comprises a measuring device 9, which is either a separate or an integral part thereof, for measuring vibration from the drill rod during impacting. The measuring device 9 measures, in particular, during impacting the vibration originating from the drilling equipment, for instance, with a sensor 10 connected to the measuring device. The sensor 10, in turn, may be e.g. a microphone measuring a sound signal, a strain-gauge transducer or the like measuring a stress wave, or an acceleration sensor measuring acceleration or another appropriate sensor. Instead of a sensor like this it is possible to use an optical measuring device. Measurement, in turn, may be performed either on the drilling equipment 6, the frame of the rock drilling rig or a relating location, on a sound propagating in the air, etc. Further, the control device comprises analyzing means 11, which, in turn, analyze the measured vibration and compare the result with the predetermined unfastened and fastened models in order to determine whether the threaded joints have loosened. The measuring device 9 and the analyzing means 11 may be a part of the control device 8 or separate devices, and they may also be implemented by a computer program included in the control device 8.

In this patent application and the claims, impacting refers to any of the following options. The drilling equipment is impacted with the percussion device of the rock drilling rig, or with a separate impacting device, in the longitudinal direction of the drill rods without feeding the drill towards the rock to be drilled. During drilling, at its final stage, at some distance before the end point of the hole to be drilled, feeding is reduced such that stress waves generated by the impacts from the percussion device of the rock drilling rig may loosen the threads despite the drilling. The threaded joint of the drill rod to be unfastened is impacted with a separate impacting device in the transverse direction of the drill rod.

FIG. 2 shows schematically how the method of the invention works. It determines, through vibration measurement or theoretically, a fastened model 12 which is to describe drilling equipment with threaded joints, which may be one or more, tightly interconnected. Further, it shows a second, i.e. unfastened, model 13, which is to describe a situation, according to measurements or theoretical determination, where the threaded joints have loosened. In practice, these models are various frequencies or frequency spectra of vibration measured from the drilling equipment or determined theoretically, or other measured or calculatory values representing the state of the threads, and consequently, as the situation changes the values change, respectively. These values are specific to each particular apparatus and they may vary, depending on the apparatuses and the equipment used, in a variety of ways.

Between the fastened and the unfastened models there is a transition phase 14, which takes place, when the threads start loosening. The transition is not a sudden jump, but it takes place gradually, yet in actual fact, within a few seconds. In this transition phase 14, for instance, vibration frequency, frequency spectrum or other representative value changes from the fastened model 12 towards the unfastened model 13, whereby between the frequencies and the frequency spectra there is a situation, which permits one to detect that the threads have loosened in a desired manner. At this point it is possible to define a threshold condition 15, which serves as a threshold value for comparing a vibration signal measured during impacting with these predetermined models.

The threshold condition 15 may be set, for instance, midway between the models or, in a desired manner, in either one of the directions on the basis of experience, in particular. So, the threshold condition may be adjustable, and it may be adjusted when the drilling equipment is changed in one way or another, or if the drilling conditions change substantially. The adjustment may also be altered, for instance, such that identification and detection become more sensitive or less sensitive depending on the situation, i.e. the detection may take place earlier or later than determined by the set threshold condition.

The threshold condition 15 may also be determined such that an experienced operator performs the impacting and the threshold condition 15 is determined on the basis of the operator's stopping situation. When desired, it is naturally possible to use several different operators, and on the basis of said operators' stopping situations it is possible create an average threshold condition, which is again alterable if so desired. In all cases the operator is either a driller, a service person or any other person that uses the rock drilling rig during operation.

The threshold condition per se may be just a particular set value of a particular variable, such as frequency. However, it may also be a mathematical function of a variable, a model representing a variable, or a model based on a curve representing a variable, even a multi-dimensional model.

The threshold condition determined between the models may be, for instance, exceeding of a selected threshold value. This threshold value may be pre-selected or determined by calculation. Examination of threshold values may also be based on a mathematical representation or function, which is calculated on vibration properties and whose value is compared with the set threshold value. Further, the condition may be that the vibration properties fall in a selected area or a property subset, for instance, if the vibration properties are examined in relation to a plurality of mathematical variables representing properties. The condition may also be a mathematical function, relation or other mathematical operation known per se. The condition may also be provided by a change in or accumulation of vibration properties examined in relation to time, for instance.

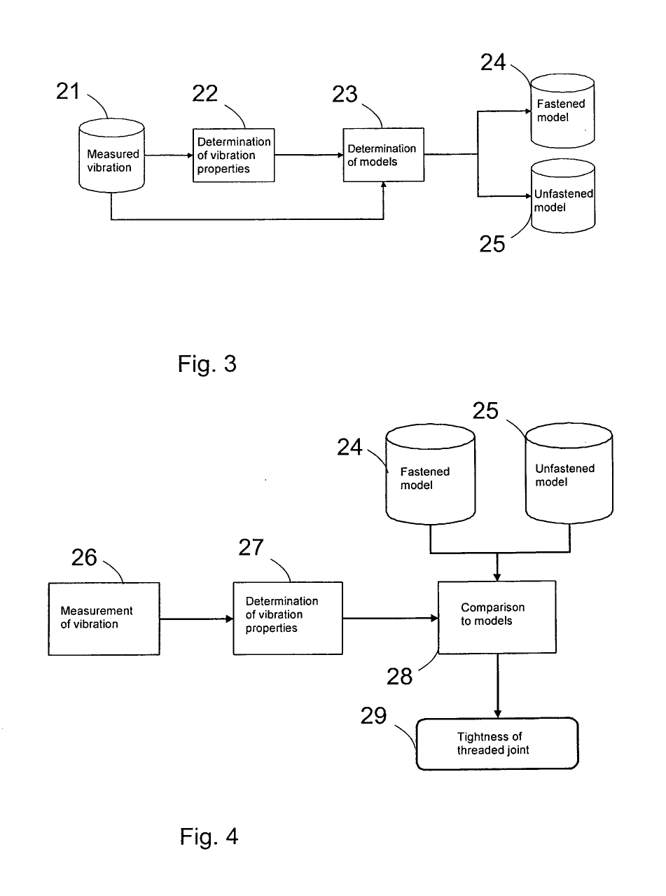

FIG. 3 shows schematically how the method of the invention may be provided to a system that works.

First, there is collected 21 vibration data on one or more different rock drilling rigs. Thereafter, the measured vibration data is processed 22, e.g. by means of mathematical statistics, in order to determine its properties. From the measured vibration it is possible to form parameters or other computational quantities that represent vibration properties by using methods known per se. These mathematical methods are commonly known per se, and therefore they need not be explained in any greater detail. Thereafter, on the basis of the measured data, there are preliminarily determined 23 fastened and unfastened models 24 and 25 and the obtained models are then utilized in the implementation of the method.

After this, the obtained models may be tested with one or more rock drilling rigs, and on the basis thereof, it is possible to make the necessary changes in the models required by the testing. Subsequently, there are optionally available several different models for different rock drilling rigs and equipment, even for different drilling conditions, and they may be classified on these grounds for use in each particular rock drilling rig. Naturally, the obtained models may be compared by means of practical experience, and when necessary, amended model versions may be made.

FIG. 4 shows schematically a manner to apply the method of the invention. It measures 26 vibration from the rock drilling rig in a previously described manner, whereafter vibration properties 27 are determined on the basis of the properties used in model determination. Next, properties of the measured vibration are compared 28 with the provided models, and on the basis of the comparison there are drawn 29 conclusions on the tightness of the threaded joints, i.e. it is concluded whether they are tightly fastened or sufficiently loosened in order for them to be opened.

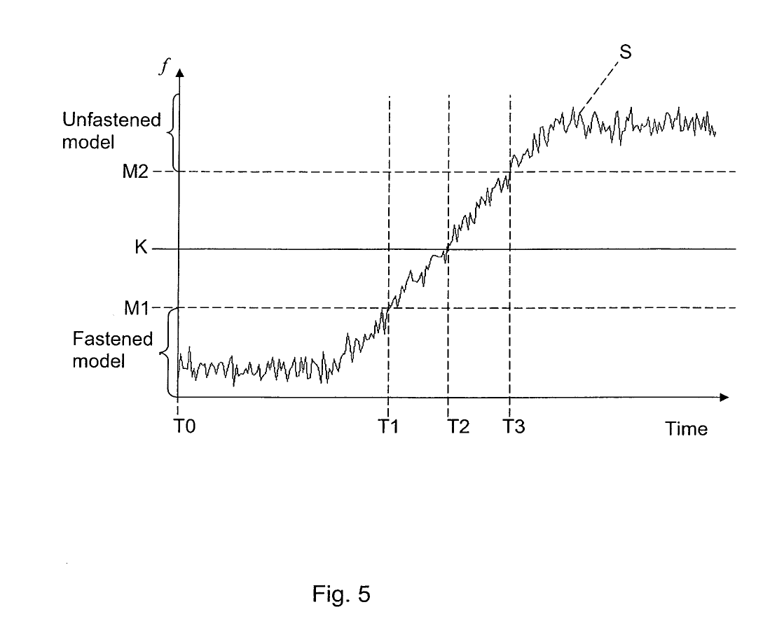

FIG. 5 shows schematically, and by way of example, a manner to apply the method of the invention. The curve shown in the figure is provided by measuring vibration frequency of drilling equipment on a rock drilling rig during impacting.

As appears from the figure, the vibration frequency of the drilling equipment is lower when the threaded joints are fastened than when they are unfastened, i.e. loosened. So, the fastened model covers a vibration frequency range lower than a particular frequency M1 and the unfastened model covers a vibration frequency range higher than a second particular frequency M2. Between them there is a vague zone, in the middle of which there is, by way of example, a threshold condition, i.e. in this case a particular, selected vibration frequency, which is utilized in determining the situation and drawing the conclusions.

During impacting, from its initial moment T0 to a time instant T1 vibration measurement indicates that threaded joints are fastened. From there onwards, up to a time instant T2 the situation is more that of a fastened state than unfastened state, but at time instant T2 the situation changes. From there onwards, up to a time instant T3 the threaded joints are more unfastened than fastened, but they are not completely loosened either, and only from a time instant T3 onwards it is possible to deem that substantially all threaded joints are completely loosened.

When the method is applied, first, two models are provided, of which one represents a fastened state and the other an unfastened state. In addition, between the models there is determined a threshold condition, which is utilized in decision making. During impacting, measured vibration is compared to both models, i.e. the fastened modeland the unfastened model, and using the threshold condition a conclusion is drawn on the state of the threaded joints.

In practice, impacting may be stopped, for instance, upon achieving the threshold condition, i.e. in this case the frequency representing it. Tight threaded joints that may still exist can be further impacted in connection with disassembly, if necessary. The threshold condition may also be adjusted, for instance, on the basis of the measurements performed in that particular drilling situation and the experience, either to be closer to the fastened model or correspondingly to the unfastened model, whereby the frequency value, used as a limit value in accordance with this example, becomes lower or higher.

Naturally, the apparatus comprises memory means for controlling, in which memory means the determined models and threshold conditions as well as other parameters and possibly also measured vibration and analyzing results thereof are stored. The memory means may be, for instance, a memory in the control device 8 or it may be a memory included in the excavation computer system, wherefrom the control device of the rock drilling rig may use it.

Above, the invention is described in the specification and drawings by way of example only and it is in no way limited to thereto. Thus, the vibration signal may be measured either directly from the drill rod or indirectly from various parts of the rock drilling rig. The vibration may be measured with appropriate measuring devices as a sound signal, ultrasound signal, acceleration, stress wave, propagation of stress wave in the drilling equipment or by other measuring methods known per se. The stress wave may be measured either from the drilling equipment, the frame of the rock drilling rig or from another suitable point in the rock drilling rig. Optical measurement, in turn, may be performed by using a laser measuring device or another optically measuring device suitable for the purpose. The measured vibration signal may be processed in various ways in order to provide a desired comparable model and a comparable signal either mathematically or by filtering acoustically, electronically etc.

After impacting, to be on the safe side, it is possible to rotate the drilling equipment in the fastening direction, whereby the opened threaded joints slightly tighten and the parts of the drilling equipment are not able to detach from one another. This may be performed also automatically such that the control device is arranged to perform a short twist of the drilling equipment in the fastening direction after impacting.

1. A method for detecting tightness of threaded joints of drill rods when unfastening at least one threaded joint of drilling equipment (6) by impacting the drilling equipment (6) with a percussion device of a rock drilling rig (1), the method predetermining at least one unfastened model for a situation where the threaded joint is unfastened, based on vibration produced in the drilling equipment (6) while being impacted, measuring vibration originating from the drilling equipment (6) during impacting and comparing a measured vibration signal with the unfastened model so as to determine the tightness in the threaded joint(s), characterized in by further predetermining at least one fastened model for a situation where the threaded joint(s) is/are fastened, comparing the vibration signal measured during impacting both to the fastened model and to the unfastened model and on the basis of the comparison determining which one of the models the tightness of the threaded joints better corresponds to at the time of determination.

2. The method of claim 1, characterized in that the models are determined theoretically on the basis of the physical properties of the drill rods (6a).

3. The method of claim 1, characterized in that the models are determined by impacting the drilling equipment (6) and measuring vibration from the drilling equipment (6) during drilling both when the threaded joint(s) are fastened and when they are unfastened.

4. The method of claim 3, characterized in that the models are determined by impacting on the basis of the activity of the operator operating the apparatus for opening the threaded joint(s) of the drilling equipment (6).

5. The method of any one of the preceding claims, characterized by determining a threshold condition between the models, on one side of which the threaded joint is deemed to be unfastened and on the other side of which the threaded joint is deemed to be fastened.

6. The method of claim 5, characterized in that the threshold condition between the models is adjustable.

7. The method of claim 6, characterized in that a control device (8) of the rock drilling rig (1) adjusts the threshold condition automatically according to the rock drilling rig (1) and/or the drilling conditions.

8. The method of any one of claims 5 to 7, characterized in that the threshold condition is determined theoretically.

9. The method of anyone of claims 5 to 7, characterized in that the threshold condition is determined experimentally such that an experienced operator performs the impacting and the impact stopping value decided by the operator is set as the threshold condition between the models.

10. The method of any one of the preceding claims, characterzed in that the vibration is measured from the rock drilling rig (1).

11. The method of any one of the preceding claims, characterized in that the vibration is measured from the drilling equipment (6).

12. The method of any one of the preceding claims, characterized in that the vibration is measured as a sound signal.

13. The method of any one of claims 1 to 11, characterized in that the vibration is measured as a stress wave.

14. The method of any one of claims 1 to 11, characterized in that the vibration is measured as acceleration.

15. The method of any one of claims 1 to 11, characterized in that the vibration is measured as mechanical vibration.

16. The method of any one of claims 1 to 11, characterized in that the vibration is measured as ultrasound.

17. The method of any one of claims 1 to 11, characterized in that the vibration is measured optically.

18. The method of any one of claims 1 to 11, characterized by measuring propagation of the stress wave in the drilling equipment (6).

19. An apparatus for detecting tightness of threaded joints of drill rods when unfastening at least one threaded joint of drilling equipment (6) by impacting the drilling equipment with a percussion device of a rock drilling rig (1), the apparatus comprising a control device (8) for controlling the rock drilling rig (1), memory means for storing a predetermined unfastened model, which represents a situation where the threaded joints of the drilling equipment (6) are unfastened, a measuring device (9) for measuring vibration originating from the drill rod during impacting, and analyzing means (11) for analyzing the measured vibration in accordance with a predetermined principle and for comparing with the unfastened model so as to determine whether the threaded joints are unfastened, characterized in that in the memory means there is additionally stored in advance at least one fastened model, which represents a situation where the threaded joints of the drilling equipment (6) are fastened, that the analyzing means (11) are arranged to compare the vibration signal measured during drilling both to the fastened model and to the unfastened model and, on the basis of the comparison, to determine which one of the models the tightness of the threaded joints better corresponds to at the time of determination.

20. The apparatus of claim 19, characterized in that the memory means are included in the control device (8).

21. The apparatus of claim 19 or 20, characterized in that the memory means store a threshold condition determined between the models, on one side of which the threaded joint is deemed to be unfastened and on the other side of which the threaded joint is deemed to be fastened.

22. The apparatus of claim 21, characterized in that the control device (8) is arranged to adjust the threshold condition on the basis of the measured results of the models.

23. The apparatus of claim 22, characterized in that the control device (8) of the rock drilling rig (1) is arranged to adjust the threshold condition automatically according to the rock drilling rig (1) and/or the drilling conditions.

24. The apparatus of any one of claims 19 to 23, characterized in that the measuring device (9) is arranged to measure vibration from the rock drilling rig (1).

25. The apparatus of any one of claims 19 to 24, characterized in that the measuring device (9) is arranged to measure vibration from the drilling equipment (6).

26. The apparatus of any one of claims 19 to 25, characterized in that the measuring device (9) is arranged to measure vibration as a sound signal.

27. The apparatus of any one of claims 19 to 25, characterized in that the measuring device (9) is arranged to measure vibration as a stress wave.

28. The apparatus of any one of claims 19 to 25, characterized in that the measuring device (9) is arranged to measure vibration as acceleration.

29. The apparatus of any one of claims 19 to 25, characterized in that the measuring device (9) is arranged to measure vibration as mechanical vibration.

30. The apparatus of any one of claims 19 to 25, characterized in that the measuring device (9) is arranged to measure vibration as an ultrasound.

31. The apparatus of any one of claims 19 to 25, characterized in that the measuring device (9) is arranged to measure vibration optically.

32. The apparatus of any one of claims 19 to 25, characterized in that the measuring device (9) is arranged to measure vibration as propagation of the stress wave in the drilling equipment (6).
